(19) United States
(12) Patent Application Publication
(10) Pub. No.: US 2008/0172137 A1
(43) Pub. Date: Jul. 17, 2008

(54) ONLINE MUSIC PRODUCTION, SUBMISSION, AND COMPETITION

(76) Inventor: Joseph Safina, Fort Lauderdale, FL (US)

Correspondence Address: BEYER WEAVER LLP, P.O. BOX 70250, OAKLAND, CA, 94612-0250, US

(21) Appl. No.: 12/013,983

(22) Filed: Jan. 14, 2008

Related U.S. Application Data
(60) Provisional application No. 60/880,193, filed on Jan. 12, 2007.

(51) Int. Cl. G06F 17/00; G06F 19/00

(52) U.S. Cl. 700/91; 700/94

(57) ABSTRACT

Methods and systems for recording music online using music recording software executable in a Web browser and for submitting the recording to a music competition conducted over the Internet are described. A user downloads pre-recorded musical beat tracks and music recording software. The software allows the user to record (with the use of a microphone) a vocal track which is an original lyrical track by the user and which is then mixed with the pre-recorded musical beat track, to form a final complete track. The final track is uploaded to a Web site, from which the musical beat tracks and the software were downloaded, and saved with the user profile. It is available for others to listen to and may be submitted by the user to a music track competition. When on the user computer, the user is able to record a genuine multi-track final recording in which the pre-recorded beat track is a separate track from the vocal track created solely by the user using the recording software downloaded from the Web site, operated by a music recording and competition service provider (“service provider”).

### CROSS-REFERENCE TO RELATED APPLICATIONS

This application claims the benefit under 35 U.S.C. § 119 of Provisional Patent Application No. 60/880,193, entitled “MUSIC SUBMISSION SYSTEM WITH ONLINE EVALUATION AND JUDGING”, filed Jan. 12, 2007, incorporated by reference herein in it entirety and for all purposes.

### BACKGROUND OF THE INVENTION

1. Field of the Invention

The present invention generally relates to online music creation and competition. More specifically, it relates to creating music tracks using recording software and submitting the music track to an online competition.

2. Description of the Related Art

The Internet has enabled the public to create music and publish it for anyone to hear. The first step of creating music has been done for decades using computer and digital technology. The Internet has provided aspiring musicians with software that may be downloaded and may be used to record and produce music. This includes software for recording vocal tracks, creating instrumental sounds, mixing the tracks together to create a final track or, more commonly referred to as a song or instrumental piece (if there are no lyrics).

Presently, online recording software does not allow users to record true multi-track recordings using software running solely in a user's Web browser. Music recording software is downloaded and stored on the user's computer. Other configurations require that the software remain on a server and that vocals or other parts of a track be transmitted over the Internet to the “studio” software for mixing, which creates timing differences and synchronization issues from streaming audio over the Internet.

### SUMMARY OF THE INVENTION

In one embodiment, a method of method of enabling the production of a musical track is described. A user is provided with one or more credits, typically upon a financial payment. The server receives a request for one or more beat tracks in exchange for the credits, wherein the one or more beat tracks are created by third parties, such as producers in the music industry. Recording software is transmitted from the server to a client computer as are the one or more beat tracks. A final music track is received from the client computer, wherein the final musical track includes a beat track and a vocal track created at the client computer by the user, and wherein the final musical track is created using the recording software. The final music track is posted on a Web site to enable other users to listen to, wherein the final musical track may be received in a first file format and is converted to a second file format to enable playback by the other users.

In another embodiment, a system for producing a musical track and operating a musical contest is described. The system has one or more processors, a network interface, and a memory. The system also includes a user registration module for registering new users, a recording software module for managing and providing recording software to client computers, a music file conversion module for converting a final music track file from a first format to a second format, and a contest execution module for executing music track contests. The memory stores producer and beat track data, user profile data, and contest-related data.

Other embodiments of the invention pertain to computer program products, including tangible, machine-readable medium, including various forms and implementations of volatile and non-volatile memory, on which are stored program instructions for implementing any of the methods described herein. Any of the methods, processes, sub-processes, threads, formulas, calculations, and the like of this invention may be represented as program instructions and/or databases, data structures, data tables, and so on that can be provided on such computer readable media.

### BRIEF DESCRIPTION OF THE DRAWINGS

References are made to the accompanying drawings, which form a part of the description and in which are shown, by way of illustration, particular embodiments:

FIG. 1 is an overview network diagram showing one configuration of components in accordance with one embodiment;

FIG. 2 is a flow diagram of an overview process of creating a final music track and submitting the track to an online music competition in accordance with one embodiment of the present invention;

FIG. 3 is a flow diagram of a process taken by a service provider in executing operations for a new user in accordance with one embodiment;

FIG. 4 is a flow diagram of a process taken by a user on the client device for producing a final music track and uploading it to the service provider Web site in accordance with one embodiment;

FIG. 5 is a flow diagram of a process of executing operations for a music contest in accordance with one embodiment;

FIG. 6 is a block diagram showing some of the modules, components, and data stored in service provider server 102 in accordance with one embodiment;

FIGS. 7A and 7B are screen diagrams showing an example of a service provider home page and an example user profile page; and

FIGS. 8A and 8B illustrate a computer system suitable for implementing embodiments of the present invention.

### DETAILED DESCRIPTION OF THE INVENTION

Methods and systems for recording music online using music recording software executable in a Web browser and submitting the recording to a music competition conducted over the Internet are described in the various figures. A user downloads pre-recorded musical beat tracks and music recording software. The software allows the user to record (with the use of a microphone) a vocal track, an original lyrical track by the user, which can be mixed with the pre-recorded musical beat track, to form a final complete track. In one embodiment, a beat track is one minute in length. In other embodiments, they may be longer or shorter. The final track, also one minute long, is uploaded to a Web site, from which the musical beat tracks and the software were downloaded, and saved with the user profile. It is available for others to listen to and may be submitted by the user to a music track competition. When on the user computer, i.e., client computer, the user is able to record a genuine multi-track final recording in which the pre-recorded beat track is a separate track from the vocal track created solely by the user using the recording software downloaded from the Web site, operated by a music recording and competition service provider (“service provider”).

Once the final track is uploaded to the Web site, the user may allow others to listen to the track and may submit it for a competition in which the user's peers and official or administrative judges, sponsored by the service provider, judge or rate the track. In one embodiment, the competition methodology involves ten rounds in one year and a final competition in which the best three from each round compete. The entire process, from the user recording tracks using pre-recorded beat tracks, uploading the final track, and the competitive process are intended to foster a community of creativity and support for new users, who may be seen as aspiring or budding musicians, who may find support not only from their online peers but indirectly from established, professional music producers, who offer their beat tracks for use, in a limited manner as described below, by the aspiring musicians. As described below, by offering their expertise via the beat tracks, the established producers may benefit in addition to the users, who have a venue to display their vocal and lyrical talents, with the music beat tracks as the “instrumental” part of the final track.

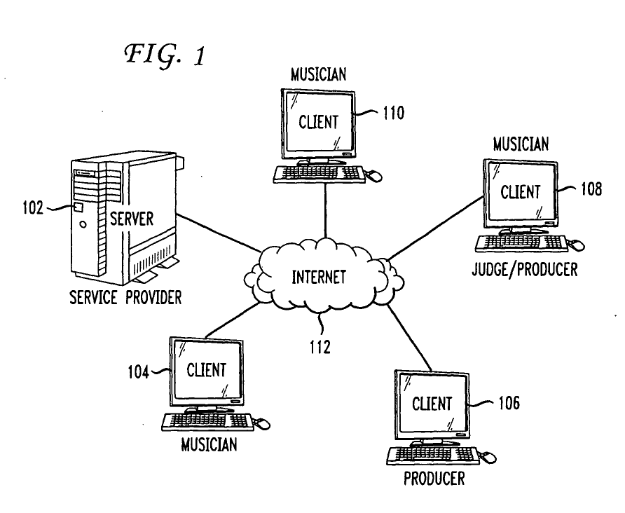

FIG. 1 is an overview network diagram showing one configuration of components in accordance with one embodiment. A server 102 is accessible by numerous clients 104, 106, 108, 110 . . . over a network, such as the Internet 112. Other networks over which numerous clients can transmit data to and receive data from a service provider server may also be used to implement the present invention. Server 102 is operated and managed by a service provider who is responsible for providing the music production software to users, storing user profiles and music, and operating the music submission and contest. All these services are described in greater detail below. One such service provider is Loud.com of Ft. Lauderdale, Fla. The service provider server 102 may be multiple servers providing various functions, such as Web services, contest operations, music production services, and so on. Clients 104 . . . 110 are, of course, merely representative of the numerous client user devices that are IP-enabled and can connect to Internet 112 and gain access server 102. Client devices may include PC, handsets, PDAs, cellphones, and the like. Users accessing server 102 via client devices include community musicians, producers, and judges (a producer may also be judge). The term “community musician” is described in greater detail below, but is essentially a user of the service provider's services who creates a music track, uploads it on server 102, and may submit it to the contest. The community musician is also a member of the creative community that the service provider is offering via server 102 where a musician can collaborate, provide feedback, discuss, and engage in a creative music community. The data and software that is transmitted over Internet 112 between the various users and server 102 are described below.

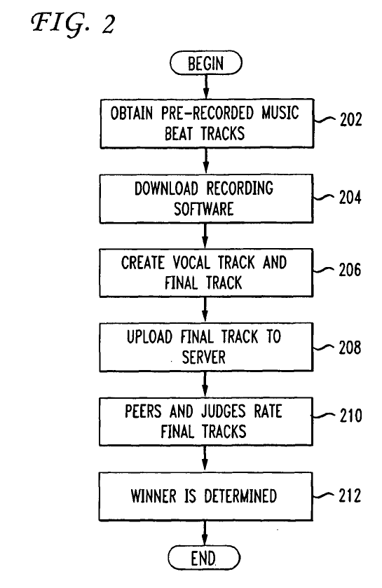

FIG. 2 is a flow diagram of an overview process of creating a final music track and submitting the track to an online music competition in accordance with one embodiment of the present invention. In one embodiment, a service provider, such as Loud.com, establishes a Web site that is ready for users to access. A community musician or user is an individual (or group of individuals performing as a single unit) who has a desire to record music. In the described embodiment, the type of music is rap and hip hop music, but the concepts of the present invention may equally apply to other types of music, specifically music that involves lyrics and singing. The service provider's Web site provides a library of pre-recorded music beats tracks which, in one embodiment, are all of the same length. In other embodiments, the lengths of the beat tracks may vary. At step 202 a user purchases the rights to use one or more beat tracks. This may be done by purchasing credits from the service provider and using the credits to buy the right to use one or more beat tracks. At step 204 the user downloads recording software from server 102 to the user's client device having a Web browser. At this time the user may also download the pre-recorded beat tracks to the user's client device, most typically a PC but may also be a handset mobile device, such as a cell phone.

At step 206 the user uses the recording software to create a vocal track or “rap” that he or she intends to use with a music beat track. The track created by the user is comprised of lyrics and a melody that the user wants to use with the beat (or rhythm) track that the user bought the rights to use. In one embodiment, the pre-recorded music beat tracks cannot be altered by the users and are used solely for use with the recording software that was downloaded from the service provider and not for any other purposes. Once the user is done recording the vocal track and mixing it with the beat track using the online recording software that executes in the user's browser, the user uploads the final track to the service provider's server 102 at step 208. In one embodiment, once the final track or tracks are uploaded to server 102, the files comprising the recording software and the final music track are deleted from the client device. In other embodiments, some or all of the files may be preserved on the client device.

At step 210 the user may submit the final track into a contest sponsored by the service provider where the user's peers (other community musicians) and administrative judges sanctioned by the service provider rate the submitted tracks in the contest. In one embodiment, three tracks that are considered the best are determined by taking a qualitative analysis of the feedback provided by community musicians who have also submitted tracks in the contest together with the more “official” rankings of the administrative judges. In many cases the judges are individuals or teams who are also producers who have provided pre-recorded beat tracks. In many cases the producers are professionals in the music industry, specifically in the hip-hop and rap music field (but are not limited to these music genres), some may be well-known and accomplished, and are qualified to act as judges of the quality of the lyrics and melodies (i.e., the “rap”) being submitted by the users, most of whom may be aspiring music artists. In one embodiment, there are numerous contest rounds, for example ten, during a certain time period, such as a year. Each contest round may produce three winners (a first, second, and third place holder). At step 212 the winners of the contest rounds compete for a final round where the best of the winners from the content rounds are chosen and a single winner is determined.

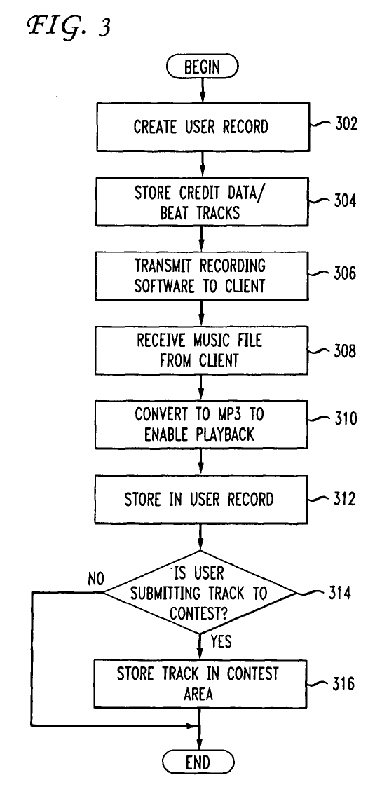

FIG. 3 is a flow diagram of a process taken by a service provider in executing operations for a new user in accordance with one embodiment. At step 302 the service provider creates a new user record when the user registers with the provider's Web site. The new user record may be seen as a storage area where all data relating to the user may be stored and organized. The record is created and stored on server 102. At step 304 data relating to credits that the user has purchased online and the beat tracks that have been exchanged for the credits are stored in the user record. A simple illustration may be “17 credits available; 6 beat tracks acquired; total initial credits purchased 23 . . . ” and the like. At step 306 the “recording studio” software is downloaded to the client from server 102 in response to a request from the user. In one embodiment, the recording software executes in the user's Web browser and is controlled by the user through the browser. The service provider may have developed the recording software or it may have licensed or purchased the software from a third party. Generally, all users obtain the same version of the “studio recording” software, however, it is possible that different versions may be available, with the more advanced versions being paid for by the users. However, it should be kept in mind that such an arrangement may affect the fairness and rules of the music contest, described below.

At step 308 the service provider receives a final music track or file from the client computing device when the user is done recording his or her track and decides to upload it to server 102. The file received is in a specific open source format referred to as .ogg file format as created and maintained by the Xiph.Org Foundation. The recording software creates music files in this format in one embodiment. In other embodiments, it may create final music files in other formats, such as MPEG Level 3 (MP3), Wave files, or other suitable files for storing music and transmitting over a network. At step 310, in one embodiment, the service provider converts the Ogg file or bitstream to MP3 format to facilitate playback of the track by the user or other users in Web site community. In some embodiments, this step may not be needed if the file is already in MP3 format when received from the user or is in a format that enables playback in users' Web browsers. At step 312 the .ogg 1 file and the MP3 file and any associated data with the music files are stored in or associated with the user record. In this manner, the track will be displayed at the user's profile page at the Web site for other users to see. In another embodiment, the user can keep the file private so that others cannot see it until the user permits it. At step 314 the service provider determines whether the user has submitted the track to the contest, described in detail below. If the user has, at step 316 the track is stored in a contest data storage area on server 102. If not, one stage of the process is complete.

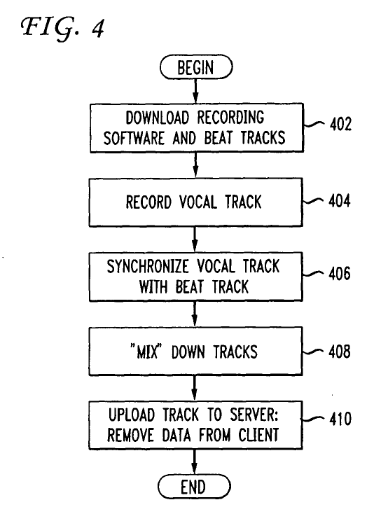

FIG. 4 is a flow diagram of a process taken by a user on the client device for producing a final music track and uploading it to the service provider Web site in accordance with one embodiment. Assuming the user has already registered with the service provider and a user record and profile has been created, at step 402 the user downloads the recording software and at least one beat track that the user has acquired using his or her credits. It is possible to download the recording software without a beat track but it would not serve any useful purpose since it is programmed for use with a beat track and a vocal track. The beat tracks are encrypted and cannot be altered by the user nor can it be used for any purpose other than for use with the user's vocal track with which it is mixed and used to create a final track that is uploaded to the service provider's server.

At step 404 the user records a vocal track using the recording software. This track is stored on the user's PC hard drive and referenced with a name assigned by the recording software. The track can be recorded using a simple microphone connected to the computer or more advanced users can use degrees of sophisticated equipment connected to the computer to create the vocal track. As noted above, the vocal track is thought of and created solely by the user. It typically has lyrics and a melody, which are matched with the beat track that the user previously selected and has downloaded. The intention is to allow the user to focus on lyrics and melody and to exhibit, in the described embodiment, his or her rapping talents. More generally, the user is able to show his or her songwriting and singing abilities. Other aspects of music, such as creating the beat track, the engineering, and so on, are done by others. The user is given the freedom to select and acquire numerous beat tracks (which contain instrumental sounds and a beat, without lyrics) that are to their taste and “lay” their rapping on top of it. This allows them to focus on what the music industry may be seeking, namely, individual musicians who have a singing (or rapping) and songwriting ability. The recording software may be used to perform some basic recording options, such as bass and treble, and may have a basic equalizer that the user can use to make adjustments to the user's rapping and singing. In the described embodiment, these options are kept simple to prevent the user from becoming too involved in the “mixing” and engineering of the track.

At step 406 the user uses the recording software to synchronize the vocal track he or she has created with the pre-recorded beat track. This is important, especially in hip-hop and rap music because the singer's lyrics must match or reflect the musical beat. At step 408 the two tracks are “mixed” down to a single final track by the recording software executing in the user's Web browser. It is useful to note that all the recording, synchronizing, and mixing done by the user and the recording software are done in the user's browser, thereby avoiding any transmissions over the Internet during the recording process. At step 410 the user uploads the final track to the service provider server 102. In one embodiment, once the upload takes place, all executable files and data files on the user's computer are deleted. In other embodiments, some of the data may remain, such as the final track or only the vocal track. At this stage the process of creating a final music track file on the user's computing device is complete.

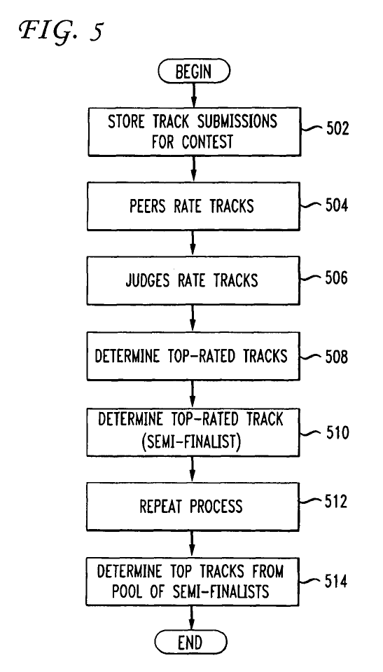

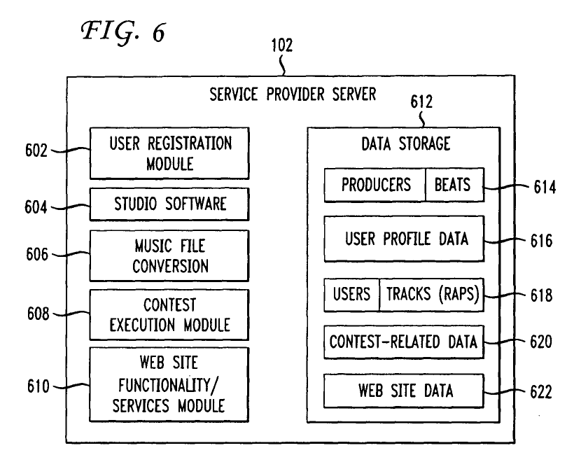

FIG. 5 is a flow diagram of a process of executing operations for a music contest in accordance with one embodiment. As noted above, in the described embodiment, there are multiple rounds, each round being one separate competition. The winners from each round compete for first, second and third place in a final competition. At step 502 the service provider receives final music track submissions from users. For example, this process may go on for a week during which users can submit their final tracks for one round of competition. These tracks or pointers to these tracks are stored in the appropriate storage area in server 102, described in FIG. 6. At step 504, the contest round has started (submissions are no longer accepted for that round) and the user's peers rate the track or tracks submitted by the user. The user's peers are other musicians on the Web site and who are part of the online music community. They do not include the professional producers or individuals involved in operating and managing the Web site. In this step, the user's track may not only be rated, for example on a scale from 1 to 5 for specific criteria, by peers but he or she may also receive comments and feedback on the track from other users in the online community. This type of open forum also provides disincentives to users who constantly provide only negative or unconstructive feedback to users. Such users will likely not receive any ratings or feedback from their peers in future contest rounds and risks being able to participate productively in the community.

At step 506 the judges appointed by the service provider rate the submitted tracks. This step may take place concurrently with step 504. In one embodiment, the judges are professionals in the music industry and many may be the producers who have provided the pre-recorded beat tracks that are used to create the final tracks by the users. They may also be other celebrities or knowledgeable people in the industry such as recorded rap and hip-hop artists, record company executives, rap and hip-hop critics, and others in the music industry. Each of the administrative judges may have a profile on the service provider's Web site or a login that is different in nature from the profile of the users. The judge's and producer's login information and profiles facilitate voting/ranking of music submissions and, for producers, uploading and managing the beats they have created and are making available on the site. Naturally, the service provider will perform all necessary technology (IT) and Web site operations for the producers and judges.

At step 508 the service provider takes the rankings from the user's peers and from the administrative judges and determines the top-rated tracks using a methodology that takes into account all the available ranking information. This methodology may vary widely. For example, the rankings from the judges may account for 75% of the weight, according the peer rankings a 25% weight, in the final analysis. In other methodologies, each may be given equal weight. In any case, in one embodiment, the top three tracks are determined for that round. At step 510 the top-rated track from the top three is determined. In one embodiment, this is done by an administrative judge, perhaps someone noteworthy, with significant experience, or a celebrity. The user who created the top-rated track for one round is referred to as a semi-finalist in one embodiment, or simply the round winner. This process—constituting one round—from steps 502 to 510, is repeated n number of times. This number is determined by the service provider. For example, if each contest round takes three weeks: accepting submissions the first week, gathering peer and judge rankings and picking the top three the second week, and determining the winning track the third week, there may be 10 rounds a year, to describe only one example out of many possible variations. At step 514, the service provider assigns a judge or judge panel to determine the top three tracks from all semi-finalist tracks. In one example, the top-rated track out of n (e.g., 10, from the illustration above), may be awarded a recording contract with a record company, while the second and third place winners are given cash prizes, at which stage the process is complete. As can be seen from this process, the online community fostered by the service provider Web site is one in which aspiring artists, specifically in the rap and hip-hop fields, can demonstrate their talents fairly inexpensively and have it critiqued and judged by others in the music business, and to advance if others believe the user has talent.

FIG. 6 is a block diagram showing some of the modules, components, and data stored in service provider server 102 in accordance with one embodiment. Server 102 has a data storage area 612 and several software modules and components. Some are shown in FIG. 6. A user registration module 602 handles the registration process for a new user, for example, creating a new user record, allocating storage space, storing user information, and so on. Studio recording software 604 is software comprising the recording software that is downloaded to users' computers and is used to record final tracks. The software may be licensed from a third party or may be created by the service provider. Software 604 may include not only the actual recording software package but all associated software for downloading the package, managing who has the software, and the like. In one embodiment, the software is for a multi-track recording studio that is easy to use and executes within a Web browser. The file that is downloaded is relatively small compared to most PC-based recording software (typically in the 10-300 megabyte range). In one embodiment, the software is written in Delphi and C++ and is customizable to make the software more advanced for more sophisticated recording options if desired in the future. In one embodiment, the software is installed in the user's Web browser using an ActiveX plug-in that installs in the Web browser. Updates to the recording software that is downloaded is automatically determined by the version of the user's Web browser. Final track files are stored as .ogg audio files. Ogg is an open standard for a free container format for digital multimedia, including audio, designed for efficient streaming and manipulation. It is maintained by the Xiph.Org Foundation. The file format is a container for Vorbis, Theora, Speex, FLAC, Dirac, and others.

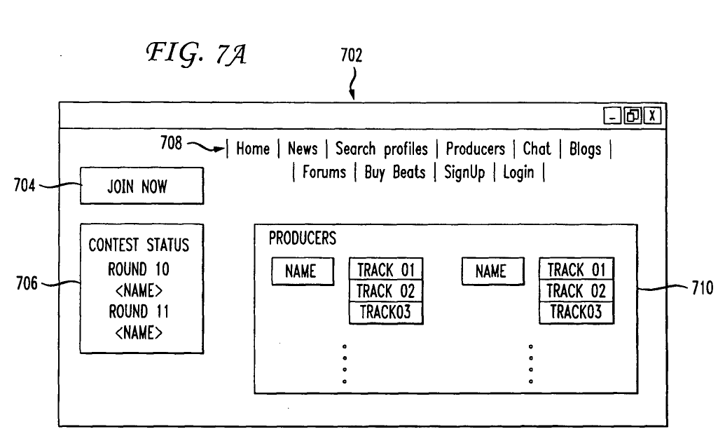

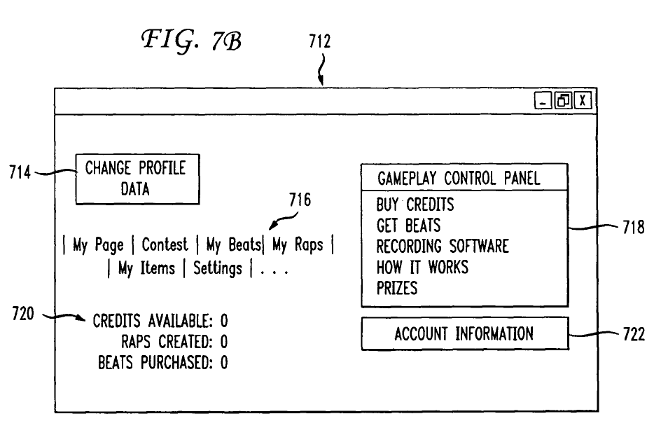

Module 606 is software for converting the .ogg music file that is downloaded from the client and created using the recording software to MP3 or another format suitable for playback in the user/creator's browser or in any of the other user's browsers (presuming they have the necessary software to play MP3 files). In this manner, the only MP3 usage is on the “back-end” of server 102 where the MP3 format is used only in the case of playback rather than music creation and distribution. Module 608 contains all the software needed generally for carrying out the contest rounds described in FIG. 5. As this may be seen as a separate component of the service's provided by server 102 (the other primary services being music production and maintaining an online music community), the software for executing the contests is stored separately. In one embodiment, contest execution module 608 may be stored and executed on a separate server associated with server 102 (and still under the operation and management of the service provider). Web site functionality/services module 610 contains general software for executing the numerous other functions of the online music community, such as maintaining chats, blogs, bulletin boards, news feeds, photos, user profiles, videos, and so on. Some of these features are described in FIGS. 7A and 7B.

Data storage area 612 stores various types of data. This includes producer data and each producer's beats in storage area 614. For example, there may be a relational database containing a record for each producer and fields for each of the beat tracks supplied by the producer. Similarly, storage area 618 contains a list of users and each user's final music track or “rap.” This data may also be contained in a relational database. Also stored is user profile data in storage area 616. This data contains all the data related to the users and is used to populate a user's home page or profile on the Web site (e.g., pictures, e-mails, comments, contest history, contact information, and so on). In one embodiment, the tracks data for each user in area 618 may be a subcomponent of profile data 616. Storage area 620 contains data on contests and all contest-related data generally. This may include data on past winners, amounts awarded, copies of the tracks which won, names of the judges, and so on. Storage area 622 contains data on all other Web site services, which may include news data, videos, bulletins, advertising data and data about the service provider such as contact information, biographies, and so on.

FIGS. 7A and 7B are screen diagrams showing an example of a service provider home page and an example user profile page. These are merely one illustration of some of the information that may be displayed to a viewer when visiting the Web site. Naturally, many variations are possible. In FIG. 7A, a logical representation of a sample screen shot 702 shows a box 704 for inviting new viewers to join as a user. A box 706 contains information on the status of the most recent contest round winners. Area 708 shows various sample links to other pages in the Web site. For example, to obtain beat tracks, a registered user can click on the “Buy Beats” link or to view detailed information on the producers, a user can open the “Producers” link. At area 710, viewers can obtain information on the various producers who have provided beat tracks (the producers may be paid a certain amount for creating and providing these tracks). A user or a non-registered viewer may be able to click on the track links and listen to the beat tracks.

In FIG. 7B, a logical representation of a sample screen shot 712 that a user may see after logging onto the site shows various types of information and links that allow the user to manage his or her profile and create final music tracks. An area 714 provides a link to the user to change the user's profile data. Area 716 shows various links that the user may use to access other information, such as “My Page” which is the home page that other users in the community will see, “Contest” for entering or getting more information on contests, “My Beats” and “My Raps” for seeing which pre-recorded beats have been purchased and which final music tracks have been completed (beat tracks mixed with vocal tracks), and so on. In area 718, referred to as a Gamplay Control Panel in the sample screen shot, a user can buy credits, get beats, download recording software, and obtain general information on how the process works and on the prizes available from the contests. Area 720 provides information on how much credit is available to the user, how many beats have been purchased, raps created, and so on. It provides a summary of the user's account. More detailed information on the user's account may be found by clicking on the link in box 722. Other information may also be available, such as bulletins or messages from other users. Of course, as with screen shot 702, screen shot 712 is merely one illustration of a sample screen shot that may be used. Naturally, there are a multitude of other variations and configurations of the two sample screen displays shown here.

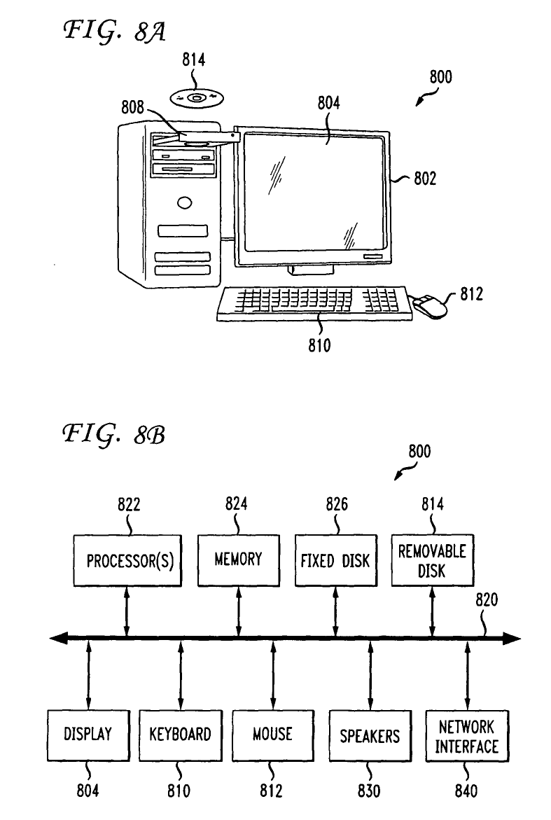

FIGS. 8A and 8B illustrate a computer system 800 suitable for implementing embodiments of the present invention. FIG. 8A shows one possible physical form of the computer system. Of course, the computer system may have many physical forms including an integrated circuit, a printed circuit board, a small handheld device (such as a mobile telephone or PDA), a personal computer or a super computer. Computer system 800 includes a monitor 802, a display 804, a housing 806, a disk drive 808, a keyboard 810 and a mouse 812. Disk 814 is a computer-readable medium used to transfer data to and from computer system 800.

FIG. 8B is an example of a block diagram for computer system 800. Attached to system bus 820 is a wide variety of subsystems. Processor(s) 822 (also referred to as central processing units, or CPUs) are coupled to storage devices including memory 824. Memory 824 may include random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 826 is also coupled bi-directionally to CPU 822; it provides additional data storage capacity and may also include any of the computer-readable media described below. Fixed disk 826 may be used to store programs, data and the like and is typically a secondary storage medium (such as a hard disk) that is slower than primary storage. It will be appreciated that the information retained within fixed disk 826, may, in appropriate cases, be incorporated in standard fashion as virtual memory in memory 824. Removable disk 814 may take the form of any of the computer-readable media described below.

CPU 822 is also coupled to a variety of input/output devices such as display 804, keyboard 810, mouse 812 and speakers 830. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 822 optionally may be coupled to another computer or telecommunications network using network interface 840. With such a network interface, it is contemplated that the CPU might receive information from the network, or might output information to the network in the course of performing the above-described method steps. Furthermore, method embodiments of the present invention may execute solely upon CPU 822 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although illustrative embodiments and applications of this invention are shown and described herein, many variations and modifications are possible which remain within the concept, scope, and spirit of the invention, and these variations would become clear to those of ordinary skill in the art after perusal of this application. For example, although the embodiments are described using .ogg file formats, other file formats may be used to transmit the final music track from the client to the server, where it may or may not be converted to MP3 for playback purposes. In another example, the service provider may only provide the music track production services and not offer the contest services or any of the other online music community services. In another example, the recording software may remain on the client after the user has downloaded the final track to the server. Accordingly, the embodiments described are to be considered as illustrative and not restrictive, and the invention is not to be limited to the details given herein, but may be modified within the scope and equivalents of the appended claims.

I claim:

1. A method of enabling the production of a musical track comprising:
providing a user with one or more credits;
receiving a request for one or more beat tracks in exchange for the credits, wherein the one or more beat tracks are created by third parties;
transmitting a recording software to a client computer;
transmitting the one or more beat tracks to the client computer;
receiving a final musical track from the client computer, wherein the final musical track includes a beat track from the one or more beat tracks and a vocal track created at the client computer by the user, and wherein the final musical track is created using the recording software; and
posting the final musical track on a Web site to enable other users to listen to, wherein the final musical track is received in a first file format and is converted to a second file format to enable playback by the other users.

2. A method as recited in claim 1 further comprising:
receiving a request to submit the final musical track to a contest in which the final musical track will compete with other final musical tracks submitted by the other users.

3. A method as recited in claim 2 further comprising:
enabling judging of the final musical track by the other users and by one or more judges.

4. A system for producing a musical track and operating a musical contest, the system comprising:
one or more processors;
a network interface;
a user registration module for registering new users;
a recording software module for managing and providing a recording software to client computers;
a music file conversion module for converting a final music track file from a first format to a second format;
a contest execution module for executing music track contests; and
a memory storage area for storing:
producer and beat track data;
user profile data; and
contest-related data.
